(19) United States
(12) Patent Application Publication
(10) Pub. No.: US 2023/0315847 A1
(43) Pub. Date: Oct. 5, 2023

(54) ARCHITECTURE AGNOSTIC SOFTWARE-GENOME EXTRACTION FOR MALWARE DETECTION

(71) Applicant: INTERNATIONAL BUSINESS MACHINES CORPORATION, Armonk, NY (US)

(72) Inventors: Dhilung Kirat, Hartsdale, NY (US); Jiyong Jang, Chappaqua, NY (US); Ian Michael Molloy, Westchester, NY (US); Josyula R. Rao, Ossining, NY (US)

(21) Appl. No.: 17/708,415

(22) Filed: Mar. 30, 2022

(51) Int. Cl. G06F 21/56

(52) U.S. Cl. CPC G06F 21/563; G06F 2221/033

(57) ABSTRACT

An approach for detection of malware is disclosed. The approach involves the use of using IR level analysis and embedding of canonical representation on a suspecting sample of software code. The approach can be applied to both malicious and benign software. Specifically, the approach includes converting a binary code to an IR (intermediate representation), canonicalizing the IR into a canonical IR, extracting one or more similarity representation based on the extracted features and comparing the one or more similarity representation to known malware.

This invention was made with U.S. government support under 2017-1707280004. The U.S. government has certain rights to this invention.

### BACKGROUND

The present invention relates generally to the field of computer science, and more particularly to systems and methods for detection and reporting of malware.

Malware is a software that is designed with malicious intent to cause, i) disruption to a computing device, computing infrastructure and/or networks, ii) retrieve user's data and information, and ii) gain unauthorized access to information or systems. A virus is a specific type of malware that self-replicates by inserting code into other software program. There are many types of malware, such as, viruses, ransomware, spyware, worms, Trojan horses, adware and rogue software.

### SUMMARY

Aspects of the present invention disclose a computer-implemented method, a computer system and computer program product for detecting malware. The computer implemented method may be implemented by one or more computer processors and may include, converting a binary code to an IR (intermediate representation); canonicalizing the IR into a canonical IR; extracting one or more similarity representation based on the extracted features; and comparing the one or more similarity representation to known malware.

According to another embodiment of the present invention, there is provided a computer system. The computer system comprises a processing unit; and a memory coupled to the processing unit and storing instructions thereon. The instructions, when executed by the processing unit, perform acts of the method according to the embodiment of the present invention.

According to a yet further embodiment of the present invention, there is provided a computer program product being tangibly stored on a non-transient machine-readable medium and comprising machine-executable instructions. The instructions, when executed on a device, cause the device to perform acts of the method according to the embodiment of the present invention.

### BRIEF DESCRIPTION OF THE DRAWINGS

Preferred embodiments of the present invention will now be described, by way of example only, with reference to the following drawings, in which:

FIG. 1 is a functional block diagram illustrating a detection environment, designated as 100, in accordance with an embodiment of the present invention;

FIG. 2A illustrates a sample software function (i.e., f1) being extracted by detection component 111 from an executable file (input) and processed all the way to a 2D graphical representation of extracted features, in accordance with an embodiment of the present invention;

FIG. 2B illustrates multiple semantically equivalent software functions (e.g., f1, f2, f3 and f4) from multiple executable files being extracted by detection component 111 and showing similarities between the four functions (e.g., f1-f4), in accordance with an embodiment of the present invention;

FIG. 2C illustrates a use case demonstration of detection component 111, in accordance with an embodiment of the present invention;

FIG. 3 is a high-level flowchart illustrating the detection component 111, designated as 300, in accordance with an embodiment of the present invention; and

FIG. 4 depicts a block diagram, designated as 400, of components of a server computer capable of executing the detection component 111 within the detection environment 100, in accordance with an embodiment of the present invention.

### DETAILED DESCRIPTION

The current state of art as it pertains malware detection, can involve, code similarity detection. Code similarity detection is a critical analysis process for detecting malware and finding relationship among variants of malware families and threat campaigns. However, existing techniques (e.g., code similarity detection, etc.) compute similarity directly from the raw binary content. Thus, these techniques can be susceptible to evasion by code mutation, using commonly seen techniques, such as, metamorphic/polymorphic code transformations, basic block shuffling, and adversarial code/data concatenations. Polymorphic malware, the malware code mutation usually performs, i) register swap, ii) redundant code insertion, iii) replace code blocks by choosing from a bag of equivalent code blocks. Other issues can include the exiting techniques not able to find similarity among binaries of the same code compiled for different architectures (e.g., 32 bit vs 64 bit).

Embodiments of the present invention recognizes the deficiencies in the current state of art as it relates code similarity detection by providing an approach. One approach involves the use of using IR level analysis and embedding of canonical representation on a suspecting sample of software code. The approach can be applied to both malicious and benign software.

Advantages and capabilities of the approach can include, but it is not limited to, i) detecting malware variants across multiple platforms and architectures including at source code level, ii) generating a robust software lineage analysis, iii) determining cyber threat attribution, iv) building a comprehensive software-genome knowledge graph, v) measuring similarity across multiple platforms and architectures vi) statically detecting code similarity using IR level analysis and embedding of canonical representation, vii) scalable and robust to noise, viii) allows fine-grained similarity calculation at various hierarchies of software components and xi) continuous similarity value allows advanced application such as clustering.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described.

It should be understood that the Figures are merely schematic and are not drawn to scale. It should also be understood that the same reference numerals are used throughout the Figures to indicate the same or similar parts.

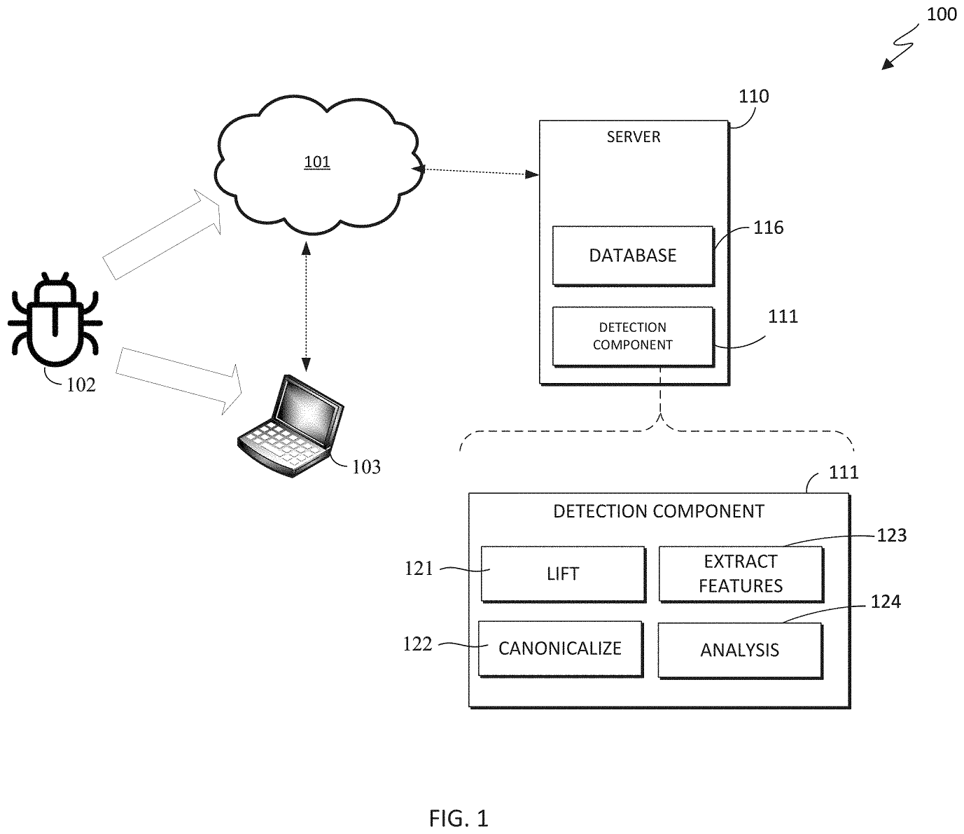

FIG. 1A is a functional block diagram illustrating detection environment, designated as 100A, in accordance with an embodiment of the present invention. FIG. 1A provides only an illustration of one implementation and does not imply any limitations with regard to the environments in which different embodiments may be implemented. Many modifications to the depicted environment may be made by those skilled in the art without departing from the scope of the invention as recited by the claims.

Detection environment 100 includes network 101, executable file 102, client device 103 and server 110.

Network 101 can be, for example, a telecommunications network, a local area network (LAN), a wide area network (WAN), such as the Internet, or a combination of the three, and can include wired, wireless, or fiber optic connections. Network 101 can include one or more wired and/or wireless networks that are capable of receiving and transmitting data, voice, and/or video signals, including multimedia signals that include voice, data, and video information. In general, network 101 can be any combination of connections and protocols that can support communications between server 110, client device 103 and other computing devices (not shown) within detection environment 100. It is noted that other computing devices can include, but is not limited to, client device 103 and any electromechanical devices capable of carrying out a series of computing instructions.

Executable file 102 are software setup files (i.e., “.exe” file) that are used to install a software on computing devices (i.e., client device 103), networks and other computerized hardware.

Client device 103 are computing devices capable for performing tasks and functions based on the pre-installed software.

Server 110 can be a standalone computing device, a management server, a web server, a mobile computing device, or any other electronic device or computing system capable of receiving, sending, and processing data. In other embodiments, server 110 can represent a server computing system utilizing multiple computers as a server system, such as in a cloud computing environment. In another embodiment, server 110 can be a laptop computer, a tablet computer, a netbook computer, a personal computer (PC), a desktop computer, a personal digital assistant (PDA), a smart phone, or any other programmable electronic device capable of communicating other computing devices (not shown) within detection environment 100 via network 101. In another embodiment, server 110 represents a computing system utilizing clustered computers and components (e.g., database server computers, application server computers, etc.) that act as a single pool of seamless resources when accessed within detection environment 100.

Database 116 is a repository for data used by detection component 111. Database 116 can be implemented with any type of storage device capable of storing data and configuration files that can be accessed and utilized by server 110, such as a database server, a hard disk drive, or a flash memory. Database 116 uses one or more of a plurality of techniques known in the art to store a plurality of information. In the depicted embodiment, database 116 resides on server 110. In another embodiment, database 116 may reside elsewhere within detection environment 100, provided that detection component 111 has access to database 116. Database 116 may store information associated with, but is not limited to, knowledge corpus of malicious malware, techniques/methods for extracting features, techniques/methods for binary lifting, techniques/methods for canonicalizing and summarization of code semantics and techniques/methods for creating similarity computational representation.

Embodiment of the present invention can reside on server 110. Server 110 includes detection component 111 and database 116.

Detection component 111 can include the following subcomponents and/or modules, lift module 121, canonicalize module 122, extract features module 123 and analysis module 124.

Detection component 111 provides the capability of converting a binary executable file (i.e., 102) into a meaningful and hierarchical representation wherein it can be used to detect the presence of malware or any benign software.

As is further described herein below, lift module 121 of the present invention provides the capability of “binary lifting” (i.e., translating) of a binary executable to a high-level intermediate representation. Conversely, an architecture agnostic binary lifting, denotes that the process of lifting can be done agnostic of any hardware platform (e.g., RISC based CPU, ARM based CPU, etc.). Being architecture agnostic will resolve the issue of the same source code being represented differently in its compiled binary form for different architectures and sometimes even for same architecture when compiled with different compilers or compiler settings. Given the input software binary, the first step is to lift the code into an intermediate representation (IR) such as LLVM-IR. This way, binary from different architectures are transformed into same IR for further processing. It is noted that LLVM is a project based on a collection of modular and reusable compiler and toolchain technologies. The LLVM Core libraries (part of the LLVM project) provide a modern source- and target-independent optimizer. The Core libraries (of LLVM) were built around a well specified code representation known as the LLVM intermediate representation (“LLVM IR”). Any current and existing binary lifting method/techniques can be used, such as program analysis, class reconstruction, and trace merging.

As is further described herein below, canonicalize module 122 of the present invention provides the capability of canonicalizing the IR form (output from lift module 121) and extracting it into its computation semantic essence. To generalize the code into its semantic essence, various techniques of canonicalization and summarization are applied to the IR representation of the binary.

Essentially canonicalization and summarization of the compiled form into a semantic essence can be summarized as, i) optimization passes are applied to remove redundant code paths introduced by malicious code mutation, ii) the addressed representation in the IR is canonicalized, iii) consistent sorting is applied to basic blocks, functions, and constants to help locality sensitive similarity and iv) contextual metadata is extracted representing higher level code properties such as the control flow graph topology. Any current and existing canonicalization method/techniques can be used, such as optimization passes from LLVM, canonicalization function from MLIR (multi-level IR) Compiler Framework etc.

As is further described herein below, extract features module 123 of the present invention provides the capability of extracting a computation friendly feature set from the canonicalized representation (output from canonicalize module 122). A computation friendly feature set is a type of software-genome. This is achieved by a two-step process: 1) serialization of canonical IR, and 2) extracting similarity representation. Serialization (i.e., step one) is just an initial input processing step that depends on the method used to extract features (i.e., step two). Thus, step one does not involve extracting any features. Is it noted that, the input for extract features module 123 is a canonicalized IR code and the output is the extracted features that represents similarity (software-genome). Some other methods may process the input IR code entirely differently, i.e., creating a call-graph and serializing the graph in some way for further processing and feature extraction.

Generally, there can be various approaches, such as, i) converting the IR into a common binary representation and then apply signal processing-based feature extraction (i.e., SigMal: a static signal processing based malware triage), ii) applying ngram-based feature extraction from the IR representation and iii) computing feature embeddings directly from the metadata and the IR representation.

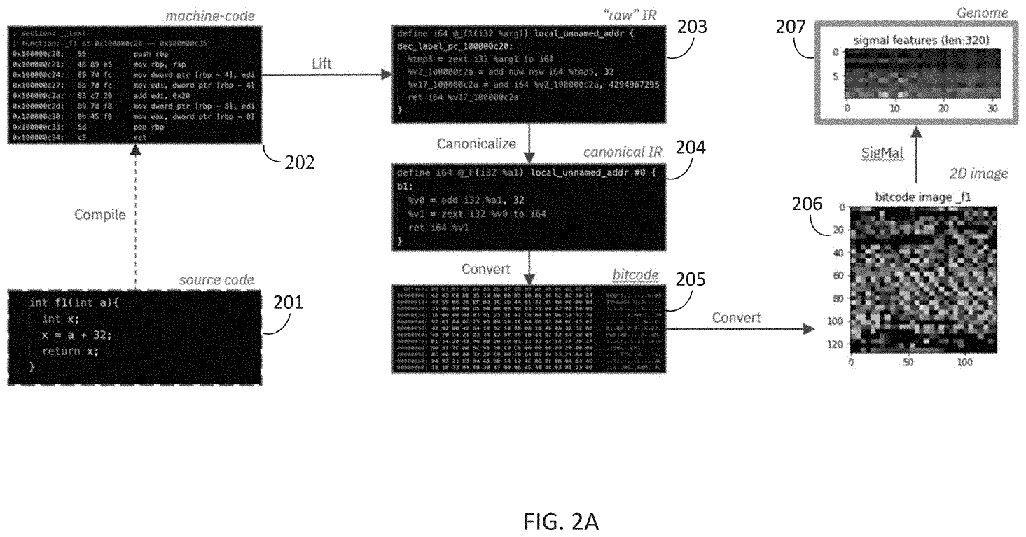

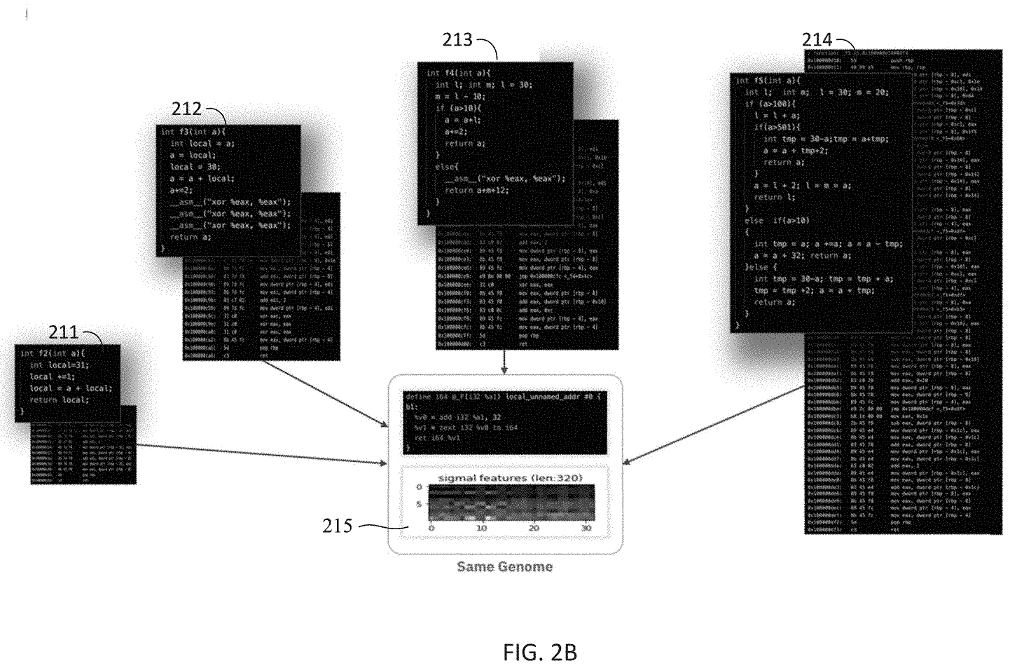

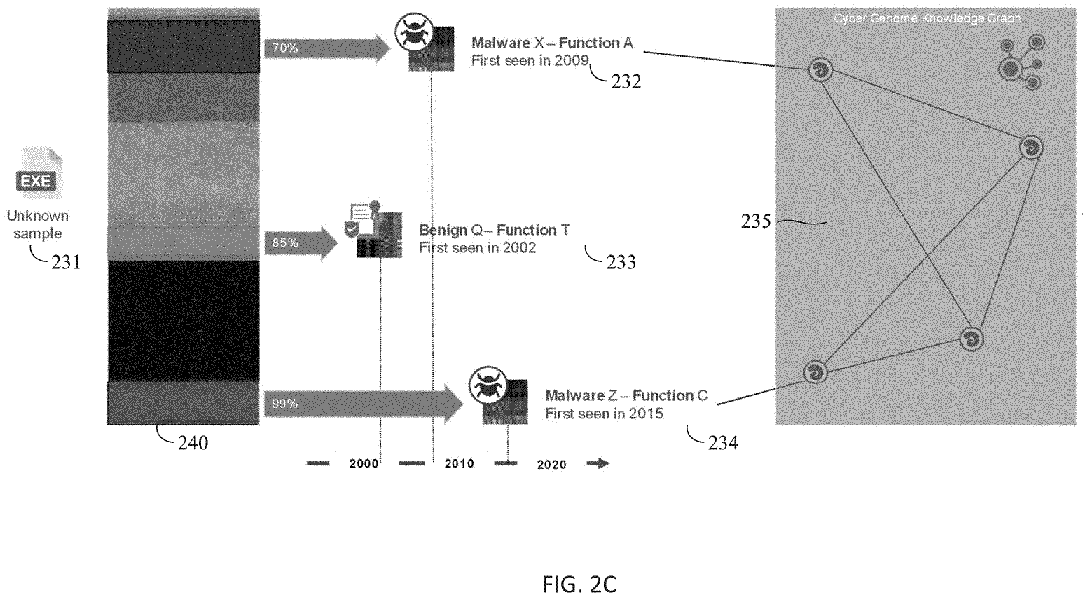

As is further described herein below, analysis module 124 of the present invention provides the capability of creating a similarity representation and comparing it against existing characteristics/features of malware from a database. Creating or constructing a similarity computation pipeline can leverage various strategies and techniques. For example, a trivial approach of using the entire binary to extract a single set feature set, or more complex feature extraction from the code sections-level features, function-level features, and even basic block-level features. Other approach may include vectorizing, bit mapping and embedding. 235 of FIG. 2C denotes a similarity representation as a cyber genome knowledge graph while 206 of FIG. 2A illustrates a 2D image. Referring to a use case in FIG. 2A, analysis module 124 may just utilize the function-level features for similarity computation (i.e., function one, f1). Another use case (referring to FIG. 2C) is the hierarchical similarity computation by applying different weights for instance for different levels of feature sets.

Another capability of analysis module 124 is the comparison functionality wherein the similarity computation representation is used to compare against existing a database of malware features (referring to FIG. 2C). Any comparison or triage techniques, such as SigMAL (a static signal processing based malware triage), maybe used to determine/assess if the possibility of malware exist within the similarity representation. SigMAL is designed to operate within systems that can process large amounts of binary samples. Specifically, many binary samples received by such systems may contain variants of previously-seen malware, and they retain some similarity at the binary level. SigMal improves the state-of-the-art by leveraging methodology from signal processing to extract noise-resistant similarity signatures from the binary samples. SigMal uses an efficient nearest-neighbor search technique, which can be scalable to millions of samples. It is noted that other comparison/malware detection techniques can be employed besides using SigMal. SigMal is only mentioned to illustrate a use case example.

FIG. 2A illustrates a sample software function (i.e., f1) being extracted by detection component 111 from an executable file (input) and processed all the way to a 2D graphical representation of extracted feature, in accordance with an embodiment of the present invention. For example, function one (i.e., f1) is one function out of numerous functions of an executable file (i.e., 201). The source code of the executable is compiled into machine code (i.e., 202). Note that any CPU compiler (e.g., ARM based, RISC based, etc.) can be used (the example shows an Intel CPU architecture-based compiler). Once the machine code has been compiled, the next step is to binary lift, via lift module 121 of detection component 111, the machine code into an intermediate representation (IR), such as LLVM-IR (i.e., 203). FIG. 203 denotes a “raw” IR of function one (i.e., f1). Next, the “raw” IR is canonicalize, via canonicalize module 122 of detection component 111, into another IR form, i.e., canonical IR 204. The next step is to extract features from canonical IR 204 via extract features module 123 of detection component 111, into a computation friendly feature set or embeddings also called software-genome. To achieve this, canonical IR is first converted to the binary bitcode 205 representation, which is further converted to an image (i.e., 206) and processed by SigMal to extract software-genome as represented as an image (i.e., 207). It is noted that function one is shown but the analysis can include other code, such as objects, libraries and class from the original executable file.

FIG. 2B illustrates multiple software functions (e.g., f1, f2, f3 and f4) from multiple executable files being extracted by detection component 111 and showing similarities between the four functions (e.g., f1-f4), in accordance with an embodiment of the present invention. All four functions, f2 211, f3 212, f4 213 and f5 21 will have completed a similar process as FIG. 2A and is represented by a 215, wherein the extracted genome (feature vector) shown by 215 indicates that all four functions have equivalent computational semantics. This demonstrates that even if a code is obfuscated and morphed (e.g., by malware creators) resulting in entirely different compiled binaries, this process is able to identify similarity among them. It is noted that functions (e.g., f1, f2, f3, and f4) are shown but the analysis can include other code, such as objects, libraries and class from the original executable file.

FIG. 2C illustrates a use case demonstration of detection component 111, in accordance with an embodiment of the present invention. An unknown executable file sample, 231, completes the same journey via detection component 111 as FIG. 2A and FIG. 2B. Map 240 is shown as a binary translation mapping of the entire file sample (231). Only three functions are being shown (e.g., function A, function T and function C) from map (i.e., 240) for the sake of brevity. Function A (i.e., 232) has a 70% chance of containing similar code to malware X (that was first detected in 2009). Function T (i.e., 233), has an 85% chance of containing benign code (detected in 2002). And function C (i.e., 234) has a 99% chance of containing malware Z (first detected in 2015). Based on the mapping (240), the representation of the three functions can be further refined and represented as cyber genome knowledge graph 235. Such similarity analysis among multiple binaries at various hierarchies and analysis of connections using knowledge graph representation is performed by the analysis module 124. It is noted that functions are shown but the analysis can include other code, such as objects, libraries and class from the original executable file.

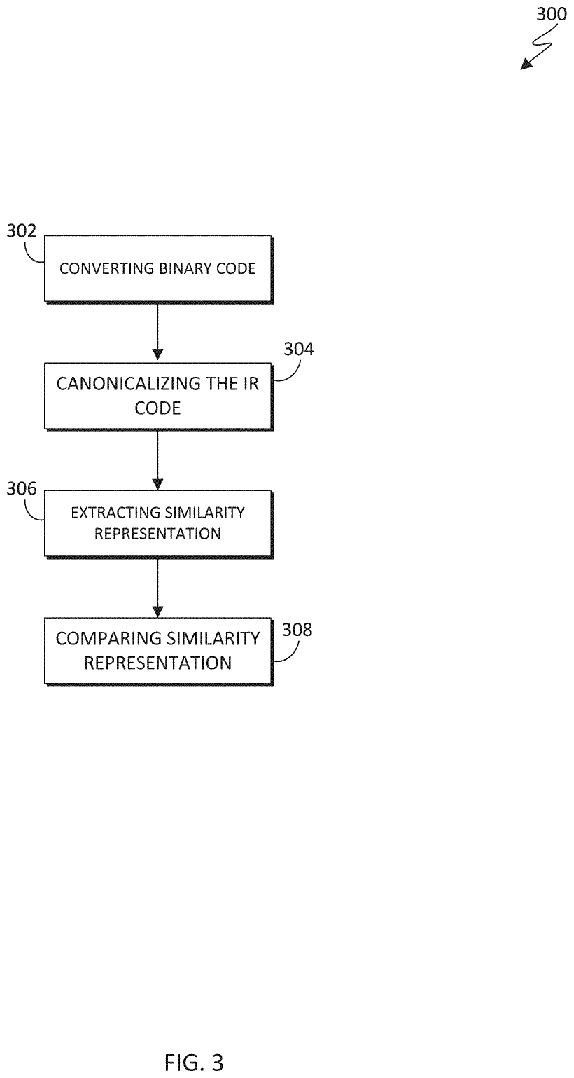

FIG. 3 is a high-level flowchart illustrating the detection component 111, designated as 300, in accordance with another embodiment of the present invention. It would be helpful to refer to the use case from FIG. 2A.

Detection component 111 converts binary code (step 302). In an embodiment, detection component 111, through lift module 121, converts a binary code from an executable file to an architecture agnostic intermediate representation (IR). For example, (referring to 203 of FIG. 2A), an incoming executable file is being processed and a portion of the code, such as function one (i.e., f1) is being used to illustrate the steps. The binary file (including f1) is being “lifted” via lift module 121 into a “raw” IR.

Detection component 111 canonicalize the intermediate representation (step 304). In an embodiment, detection component 111, through canonicalize module 122, canonicalize the raw IR into a canonical IR form. For example, the raw IR portion of the binary file code from step 302 is canonicalize as a canonical IR form (referring 204 of FIG. 2A).

Detection component 111 extracts a similarity representation (step 306). In an embodiment, detection component 111, through extract features module 123 and/or analysis module 124, extracts a similarity representation based on the serialized input from the prior step. Extract features module 123, can take the input (i.e., canonical IR form) and create an output, which is the extracted features that represents similarity (software-genome). For example, SigMal-based similarity representation of function one (i.e., f1) from the prior step is extracted from a serialized bitcode data (referring 206 of FIG. 2A). Any existing techniques can be utilized to convert the serialized data into a similarity representation. It is noted that for illustrative purpose, a bitcode image is utilized.

Detection component 111 compares the similarity representation (step 308). In an embodiment, detection component 111, through analysis module 124, compares the similarity representation to a known malware database. Any existing techniques can be used for comparison and determining similarity, such as cosine similarity, average distance and etc.

For example, similarity representations of multiple binaries can be analyzed to determine whether function one is similar to any existing malicious (or benign) software. After the analysis, the user can be notified or shown on the screen that function one is a benign function. Similarly, the entire executable file can be processed using steps 302 through 310 to determine if any or the entire executable file is benign or contain some malicious code. It is noted that other comparison/malware detection techniques can be employed besides using SigMal. SigMal is only mentioned to illustrate a use case example.

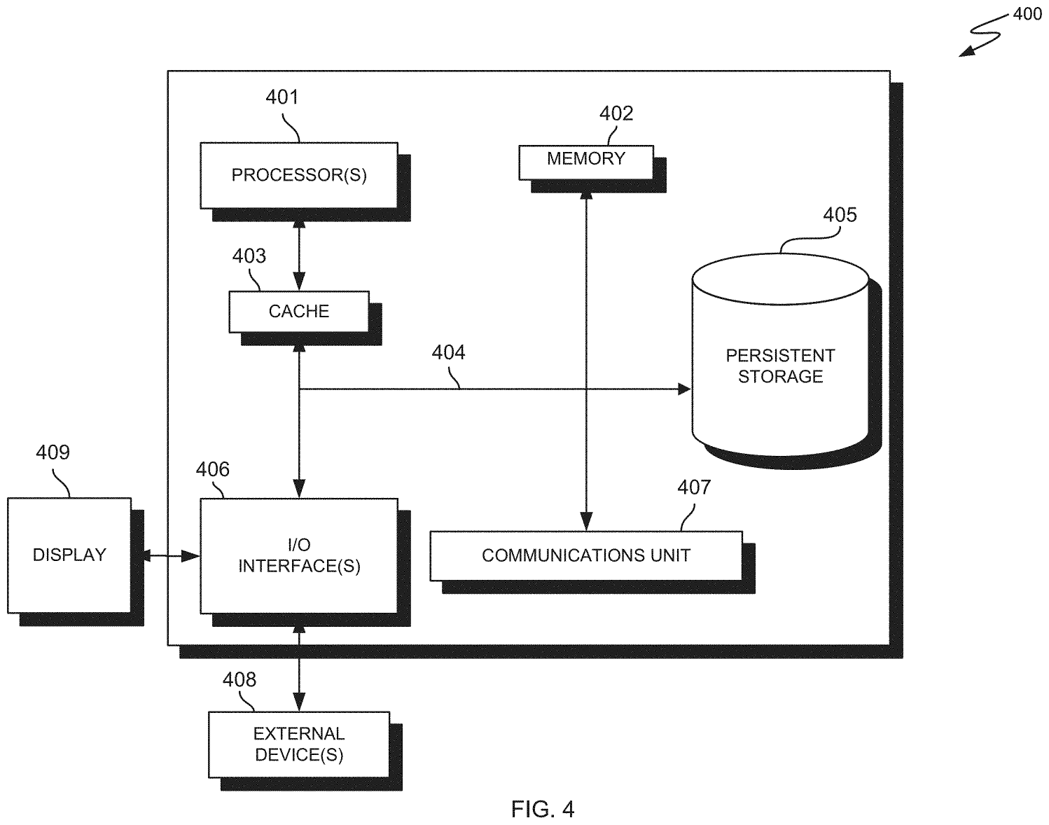

FIG. 4, designated as 400, depicts a block diagram of components of detection component 111 application, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

FIG. 4 includes processor(s) 401, cache 403, memory 402, persistent storage 405, communications unit 407, input/output (I/O) interface(s) 406, and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processor(s) 401 by holding recently accessed data, and data near recently accessed data, from memory 402.

Program instructions and data (e.g., software and data x10) used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. Detection component 111 can be stored in persistent storage 405 for access and/or execution by one or more of the respective processor(s) 401 via cache 403.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data (e.g., detection component 111) used to practice embodiments of the present invention may be downloaded to persistent storage 405 through communications unit 407.

I/O interface(s) 406 allows for input and output of data with other devices that may be connected to each computer system. For example, I/O interface(s) 406 may provide a connection to external device(s) 408, such as a keyboard, a keypad, a touch screen, and/or some other suitable input device. External device(s) 408 can also include portable computer readable storage media, such as, for example, thumb drives, portable optical or magnetic disks, and memory cards. Program instructions and data (e.g., detection component 111) used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

What is claimed is:

1. A computer-implemented method for detection of malware, the computer-method comprising:
converting a binary code to an IR (intermediate representation);
canonicalizing the IR into a canonical IR;
extracting one or more similarity representation based on the extracted features; and
comparing the one or more similarity representation to known malware.

2. The computer-implemented method of claim 1, wherein converting the binary code to intermedia representation further comprises using binary lifting.

3. The computer-implemented method of claim 1, wherein the intermediate representation further comprises LLVM-IR.

4. The computer-implemented method of claim 1, wherein canonicalizing the IR into the canonical IR further comprises the use of optimization passes, address representation, consistent sorting and extracting contextual metadata.

5. The computer-implemented method of claim 1, wherein serializing features from the canonical IR comprises the use of converting into common binary representation, applying ngram-based feature extraction and computing feature embedding directly from metadata.

6. The computer-implemented method of claim 1, wherein the one or more similarity representation comprises the use of extracting a single set of a feature set, extracting section-level features, function-level features and block level features and applying different weights to different level of the feature set.

7. The computer-implemented method of claim 1, wherein comparing the one or more similarity representation to known malware further comprises the use of SigMal.

8. A computer program product for detection of malware, the computer program product comprising:
one or more computer readable storage media and program instructions stored on the one or more computer readable storage media, the program instructions comprising:
program instructions to convert a binary code to an IR (intermediate representation);
program instructions to canonicalize the IR into a canonical IR;
program instructions to extract one or more similarity representation based on the extracted features; and
program instructions to compare the one or more similarity representation to known malware.

9. The computer program product of claim 8, wherein program instructions convert the binary code to intermediate representation further comprises using binary lifting.

10. The computer program product of claim 8, wherein the intermediate representation further comprises LLVM-IR.

11. The computer program product of claim 8, wherein program instructions canonicalize the IR into the canonical IR further comprises the use of optimization passes, address representation, consistent sorting and extracting contextual metadata.

12. The computer program product of claim 8, wherein program instructions serialize features from the canonical IR comprises the use of converting into common binary representation, applying ngram-based feature extraction and computing feature embedding directly from metadata.

13. The computer program product of claim 8, wherein the one or more similarity representation comprises the use of extracting a single set of a feature set, extracting section-level features, function-level features and block level features and applying different weights to different level of the feature set.

14. The computer program product of claim 8, wherein program instructions compare the one or more similarity representation to known malware further comprises the use of SigMal.

15. A computer system for detection of malware, the computer system comprising:
one or more computer processors;
one or more computer readable storage media; and
program instructions stored on the one or more computer readable storage media for execution by at least one of the one or more computer processors, the program instructions comprising:
program instructions to convert a binary code to an IR (intermediate representation);
program instructions to canonicalize the IR into a canonical IR;
program instructions to extract one or more similarity representation based on the extracted features; and
program instructions to compare the one or more similarity representation to known malware.

16. The computer system of claim 15, wherein program instructions to convert the binary code to intermedia representation further comprises using binary lifting.

17. The computer system of claim 15, wherein the intermediate representation further comprises LLVM-IR.

18. The computer system of claim 15, wherein program instructions to canonicalize the IR into the canonical IR further comprises the use of optimization passes, address representation, consistent sorting and extracting contextual metadata.

19. The computer system of claim 15, wherein program instructions to serialize features from the canonical IR comprises the use of converting into common binary representation, applying ngram-based feature extraction and computing feature embedding directly from metadata.

20. The computer system of claim 15, wherein the one or more similarity representation comprises the use of extracting a single set of a feature set, extracting section-level features, function-level features and block level features and applying different weights to different level of the feature set.
